(19) United States
(12) Patent Application Publication
(10) Pub. No.: US 2008/0275819 A1
(43) Pub. Date: Nov. 6, 2008

(54) System and Method for Transaction Payment in Multiple Languages and Currencies

(76) Inventor: Paul Rifai, Geneve (CH)

Correspondence Address: OBLON, SPIVAK, MCCLELLAND MAIER & NEUSTADT, P.C., 1940 DUKE STREET, ALEXANDRIA, VA, 22314, US

(21) Appl. No.: 11/912,075

(22) PCT Filed: Dec. 30, 2004
(86) PCT No.: PCT/EP2004/053738

§ 371 Date: Oct. 19, 2007

(30) Foreign Application Priority Data
Oct. 15, 2004 (IB) PCT/IB2004/003387

(51) Int. Cl. G06Q 20/00; G07B 15/00

(52) U.S. Cl. 705/44

(57) ABSTRACT

The invention relates to a method and system for transaction payment wherein user identification data from an identification module (100) are transmitted to a central dispatch module (107) over a first communication channel (101), wherein the user is identified in a database (103) based on the user identification data, wherein the transaction data are sent to processing module (105/106), wherein the central dispatch module (107) compares the received user identification data with the user identification data stored in the authentication database (103) and authenticates a user by means of the central dispatch module (107) if the probability of match of the received user identification and stored user identification data is above a predefined threshold, wherein the central dispatch module (107) retrieves one or more personal data records corresponding to the authenticated user from the database (103) based on the user identification data and the authentication data and modifies at least one personal data record of the user based on the time and/or place and/or mode of the data retrieval, wherein the central dispatch module (107) transmits one or more personal data records of the user to at least one corresponding processing module (105/106) based on the personal data records of the user, and wherein a confirmation of the transaction is sent to the user over a second communication channel (108).

### FIELD OF THE INVENTION

The present invention relates generally to conducting financial transactions, and, more particularly, to a system and method to conduct financial transactions by means of mobile transaction devices in connection with personal communication means.

### BACKGROUND OF THE INVENTION

Present day transportations, parking and information systems in towns, for public and private, are usually based on board or screen machines. Information about the use of these machines cannot be easily found or read, not always provided in the customer language, or in some case does not exist at all, which produces a need for some important manipulations before getting to be able to use it. A huge number of vending machines or parking meters still require insertion of coins or special smart cards to pay travelling tickets or parking tickets. One of the further most typical situations that still requires use of cash is in the collection of fees at vehicle-accessed payment gateways such as tollbooths, vehicular kiosks, smog-certification stations, and the like. The collection of fees at these gateways is always time consuming and subject to fraud. In addition, possibilities for payment in different currencies are not always available if the customer can not use a credit card.

To solve these problems, various systems for the electronic payment of fees at payment gateways have been developed using fixed sensors interacting remotely with devices carried by passing vehicles or persons. Such systems incorporate, for example, a pre-paid token or card in the devices in which the fee is deducted from the device. In many cases, these systems offer anonymity but are inflexible as a device needs to be purchased for each specific financial transaction to be conducted. In addition, the financial transactions are insecure and are not fund-transfer transactions. Moreover, these systems do not offer real-time settlement of transactions. Finally, if the device is stolen, the funds may be used by anyone in possession of the device. Payment and tax collection for transportation and parking services is a good example: The person who wishes to use a pay card for transportation or parking must first find the nearest machine, must have in hand the correct currencies and change, usually coins, or special cash cards, has to know in advance exactly his car plate number or the place number on the floor which some times do not appears due to the snow or dust on the floor, the time that he will be parking, understand conditions prices of the systems that is some times in different languages. After having paid normally the driver has to return to the vehicle in order to place a parking ticket or other form of proof of payment in the vehicle, to be visible to parking attendants or in public transport condition user has to keep his ticket with him as a proof.

In addition, public authorities today do not have control mechanisms covering all aspects of their daily routine. When the police department is looking for a car that has been stolen, it is not always easy to locate it, even if it has been hidden in a particular parking or if the motoring services have towed the car. In any case, several companies or public departments need to be advised at the same time. The coordination between these different services and departments is not always easy to organise and accomplish. Moreover, it is difficult to pass the information between car owners and the public authorities: If the police department wants to inform an owner of the stolen car that his/her vehicle has been found, it might take a full day or more before he gets the information.

When it comes to city authorities' needs, government and authorities search for compatibility between different services to interact on different level. An example is the P&R-service (Park & Ride) where a driver can park his car and take the bus with a special discount. Or if a driver needs to order online a temporary resident parking permit, this is still not possible in all towns which constrains the driver to go to the city office authorities and loose hours before getting his special label. In case of fine services if a driver receive a fine he still have to receive first the invoice then go to the post office to pay it or use the E-banking services then the authorities receive the payment. There is still no direct online service offered by the authorities to pay it directly. Enforcement officers today do not have the possibility to interact with different departments to send a fine or to obtain online information on their portable terminals as—in a majority of cities—they still have terminals that only store and forward the information once a day (usually at the end of the day).

Finally, the mobility of persons, together with the mobility of goods and services, has produced a need for systems that are able to manage payment at almost any place in order to provide a comfort and required security to the user. Different systems for mobile payment solutions have been developed and implemented by mobile and telecom operators. These solutions however do not always correspond with the customer needs or requirements of local government and other authorities. The problem comes from the fact that mobile operators do not always share the information with other mobile competitors. When it comes to public services, this creates a limitation for mobile users to access different public services if only one operator is having the exclusivity of the service. Motoring service today do not have the ability to check and receive online information or to charge the driver when they are on the road with a communication device that can send and update the database of the authorities like the police department and car office authorities at the same time. In addition, cash-free payment and ticket-free ride would also bring huge benefits to users in public transportation means.

What is required is a system and method for the real-time, cash-free settlement of financial transactions that provide anonymity and security, that can be used virtually anywhere and that offer an inexpensive and reliable control mechanisms for public authorities or companies in charge of the management and control.

### BRIEF SUMMARY OF THE INVENTION

The present invention solves the above-mentioned and other additional problems. It relates to a fixed and/or mobile and/or wireless communication method and system for transaction payment dedicated to city authorities, public and private services, operating in multiple languages and currencies.

One aspect of the present invention is a method for transaction payment where user identification data from an identification module are transmitted to a central dispatch module over a first communication channel, where the user is identified in a databank based on the user identification data, and where the transaction data are sent to processing module, wherein the central dispatch module compares the received user identification data with the user identification data stored in the authentication databank and wherein a user is authenticated by means of the central dispatch module if the probability of match of the received user identification and stored user identification data is above a predefined threshold, wherein after a successful authentication, the central dispatch module retrieves one or more personal data records corresponding to the authenticated user from the databank based on the user identification data and the authentication data and modifies at least one personal data record of the user based on the time and/or place and/or mode of the data retrieval, wherein the central dispatch module transmits one or more personal data records of the user to at least one corresponding processing module based on the personal data records of the user, and wherein a confirmation of the transaction is sent to the user over a second communication channel. The advantages of this aspect of the invention are amongst others the possibility to proceed to payment of transactions in an highly secure and convenient way. In addition, a huge number of service providers, as well as public authorities and other control bodies can easily and effectively be incorporated in a system which offers an high level of interconnectivity and cooperation between individual service providers.

In another aspect of the present invention, the user identification module is an RFID tag and/or a bubble tag and/or a SIM-car and/or a smart card with biometric information and/or a car plate. The advantages of this aspect of the invention are amongst others the use of a standardised digital and/or analogue identification methods which provide existing high level of security and protection of data, together with additional features such as absolute position determination or unique indexing mechanisms.

In another aspect of the present invention, the first communication channel between the user identification module and the central dispatch module comprises a wireless networks such as GSM and/or GPRS and/or EDGE and/or UMTS and/or W-CDMA and/or SCDMA and/or WLAN and/or Bluetooth and/or DECT and/or satellite and/or GPS and/or private radio network. The advantages of this aspect of the present invention are among others the ability to transmit the user identification data from the user identification module to the central dispatch module without a physical contact, which is known from the state of the art card readers and similar devices. The overall comfort and easiness of use for the users are incremented in a high proportion.

In another aspect of the present invention, the personal data records of the user stored in the databank comprise image information. This aspect of the invention has the advantage of allowing a simple additional identification of the users through an police or enforcement officer or empowered employee of a service company. Moreover, the specialised cameras can extract the information automatically and compare it to the databank records in order to achieve further identification precision and decrease the fraud quota.

In yet another aspect of the present invention, a confirmation of the transaction is sent to a mobile communication device of the user. The advantages of this aspect of the present invention are among others the possibility to transmit confirmations to the user without needs for additional, dedicated devices. Moreover, the use of a second communication channel aims at decreasing the probability of fraud due to supervision of the first communication channel. The confirmation of the transaction can be stored in the mobile communication device and used for future identification, i.e. in the public transportation means.

Another aspect of the present invention uses a limited time validity for the confirmations of the transaction sent to the mobile communication device of the user. The advantages of this aspect of the present invention are among others a further elimination of fraud possibilities and increased security of transactions.

In another aspect of the present invention, the confirmation of the transaction sent to the mobile communication device of the user has to be validated by introducing a personal identification code. The advantages of this aspect of the present invention are among others additional security in the transactions.

In another aspect of the present invention, the central dispatch module is implemented in a mobile device. The advantages of this aspect of the present invention are among others an increased flexibility in the use of the systems and methods according to the present invention. A mobile device can be placed literally anywhere, including portable mobile devices user by police officers, enforcing officers or employees of service providers, so that they can quickly implement the invention.

In another aspect of the present invention, the processing modules connected to the service providers are redundant. The advantages of this aspect of the present invention are among others a high reliability of the system able to alleviate brake-downs of certain processing modules still offering the full service.

Yet another aspect of the present invention places underlying components of the system in a ring and/or star architecture. The advantages of this aspect of the present invention are among others an additional level of reliability of the system, giving the possibility of communication between the underlying components even if certain parts of the communication infrastructure should not be working.

Additional features and advantages, as well as a more complete understanding of the present invention will be set forth in the detailed description which follows, and in part will be readily apparent to those skilled in the art from that description or recognised by practicing the invention as described herein, including the detailed description which follows, the claims, as well as the appended drawings.

It is to be understood that both the foregoing general description and the following detailed description are merely exemplary of the invention, and are intended to provide an overview or framework for understanding the nature and character of the invention as it is claimed. The accompanying drawings are included to provide a further understanding of the invention, and are incorporated and constitute a part of this specification. The drawings illustrate an embodiment of the invention, and together with the description serve to explain the principles and operation of the invention.

### BRIEF DESCRIPTION OF THE DRAWINGS

In order to illustrate the system reference is made to the charts on pages 1 to 3 of the drawings.

FIG. 1 is a block diagram representing one particular embodiment of the system ant the method for transaction payment according to the present invention.

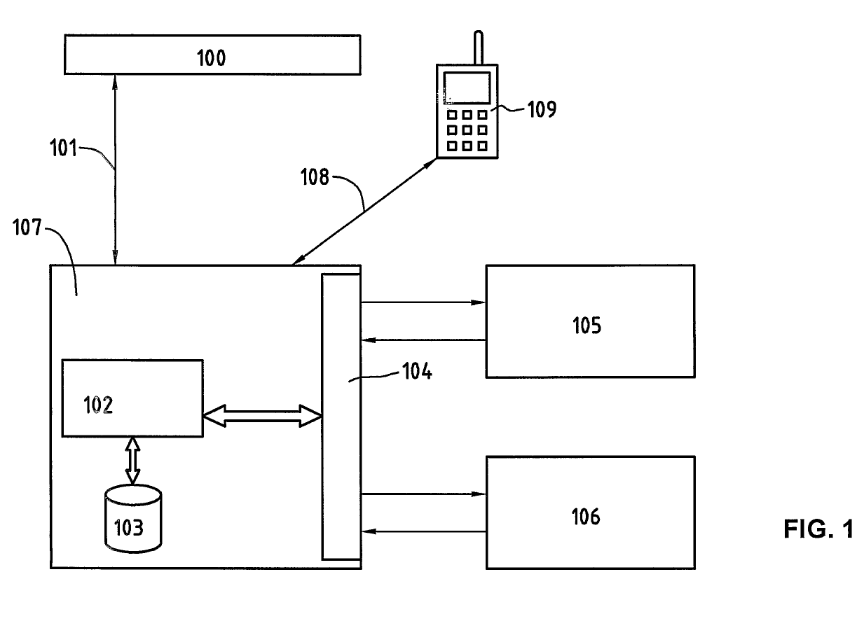

FIG. 2 is a block diagram showing another particular embodiment of the system for transaction payment according to the present invention.

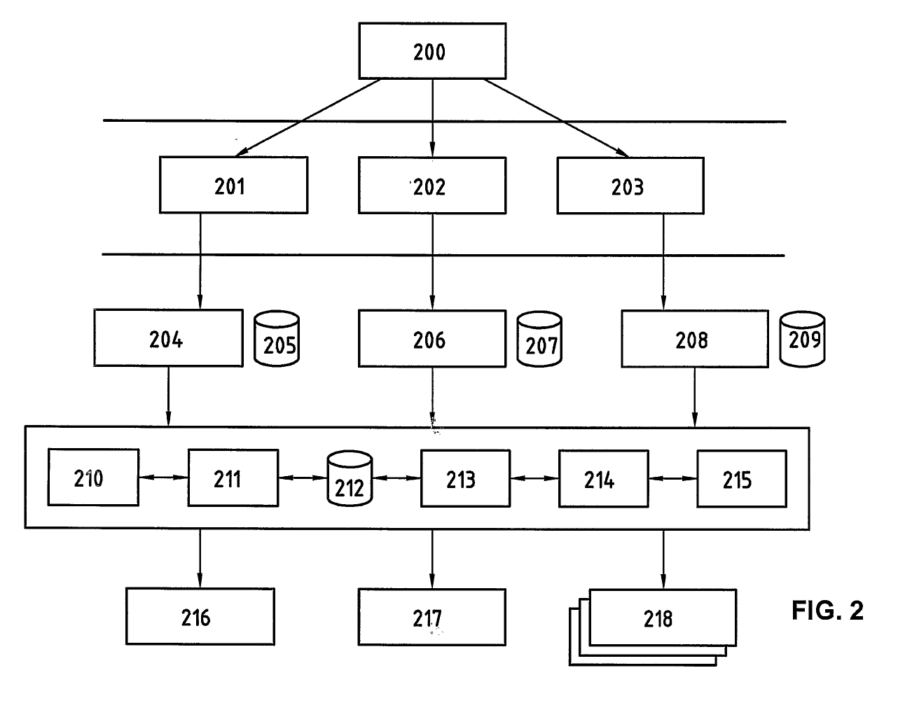

FIG. 3 is the flow diagram representing one particular embodiment of the method for transaction payment according to the present invention.

### DETAILED DESCRIPTION OF THE INVENTION

The method and the system according to the present invention will become apparent to those skilled in the art upon consideration of the following detailed description of illustrative embodiments exemplifying the best mode of carrying out the method as presently perceived.

A user willing to use the method and the system for transaction payment according to the present invention in connection with car parking applies the following six steps:

1. Subscribe to the service via a telephone call to the transaction centre or by internet, provide all required data such as name, address, bank account number etc. and open a corresponding virtual account, and receive the identification tag 100, for example the RFID or Bluetooth sticker or any other smart card.

2. Install the received identification tag 100—i.e. RFID, Bluetooth sticker, smart card—on a place where it can be seen from devices and people being outside the car. The identification tag can preferably be placed behind the car window.

3. Enter the parking facility. The reading device takes the identification data from the identification tag 101 and sends them to the central dispatching module 107 for further processing.

4. The central dispatching module 107 modifies the user data records adding the time and the place of the entering into the parking facility and transmits them to the service module 105/106 corresponding to the parking management company.

5. When leaving the parking facility, the identification of the user will follow in the same manner as in the step 3. The corresponding data records are modified by the central dispatching module 107 and sent again to the service module 105/106.

6. A confirmation of the transaction is sent to the mobile communication device of the user 109 via an SMS and/or MMS message. He might be asked to enter a personal identification code in order to validate the transaction.

It is apparent to those skilled in the art that the first step in the use of the present invention in connection with car parking or any other application can be modified such that the subscription of users to the service can be achieved through a service provider, without a direct implication of the user. These service provider would in this example act as a proxy between the users and the service, allowing users to benefit from services without a direct connection to the service itself.

A user willing to use the method and the system for transaction payment according to the present invention in connection with purchasing tickets for transportation means such as buses and/or trains and/or planes applies the following three steps:

1. Subscribe to the service via a telephone call to the transaction centre or by internet, provide all required data such as name, address, bank account number etc. and open a corresponding virtual account associated to the phone number of the user.

2. Call the service with the Integrated Voice Response System (IVR), choose the corresponding ticket-purchase service and give the destination.

3. Hang-up the call and receive the confirmation of the purchase on the mobile phone.

A user willing to use the method and the system for transaction payment according to the present invention in connection with resident parking facilities applies the following three steps:

1. Subscribe to the service via a telephone call to the transaction centre or by internet, provide all required data such as name, address, bank account number etc. and open a corresponding virtual account associated to the phone number of the user.

2. Install the received identification tag 100—i.e. RFID, Bluetooth sticker, smart card—on a place where it can be seen from devices and people being outside the car. The identification tag can preferably be placed behind the car window.

3. Each time the user enters the parking facility, the registration with the system is effectuated and the transaction is booked to the corresponding virtual account.

For an overview of the current account state, billing information, duration of used time and authorisation check, the user can access the system via internet or any other communication network. For payment transaction, settling amounts due and similar, a toll free number with an access code is provided to the customer. An IVR system guides the customer to his needs. The same service can be offered via internet.

The present invention can work with and use all types of communication devices or identifications systems. Examples of these devices or systems are electronic signature, transponder card, RFID cards comprising UHF (Ultra High Frequencies) RFID technology and/or RFID standards 809.6 and 809.7, smart cards, Interactive Voice Response (IVR) and/or voice recognition systems, then wireless protocols such as radio frequencies, fixes networks, Bluetooth, modem, wireless modems, (Secure Itinerant Digital Identity Verification (SIDIV), Secure Contactless Technology (SCT), biometric systems, mobile telecommunication networks, personal digital assistants (PDA), electronic tags, barcode scanners, TV systems, fixed or mobile photo systems, fixed or mobile monitors, fix or mobile cameras with navigation systems; software such as Netscape, lynx browser, opera, or algorithms such as GIF (Graphical Interchange) TIFF (Tagged Image File Format) or TGA (Targa), PNG (Portable Network Graphics) or JPEG (Joint Photographic Experts Group). Furthermore, the system can make use of additional elements such as recorders NTSC, PAL, SECAM, Wi-Fi, ADSL, XADL, FTP (File Transfer Protocol), SMTP (Simple Mail Transport Protocol), HTTP (HyperText Transfer Protocol), MIME (Multi-Purpose Internet Mail Extensions), dialup access, internetwork, Internet, Intranet, TCP-IP or TCP (Transmission Control Protocol), Extranet, Fixnet, (Local Area Network or LAN), Ethernet or Token Ring, GPS, WAP, GPRS, UMTS, Wi-max, Bluetooth and others to transmit or receive the information as well as extensions of these applications.

The system is intended for police departments, public authorities with multilingual population with one or several currencies that enable transportation facilities, parking authorities, facility management companies, provider of public and private parking, warden officers and like, to supervise, secure, control, inform, sell, invoice, adjust, allocate, manage, amend, collect, or refund any payment for all type of transportations and parking facilities, or information services, and all other services that public authorities or private companies need in this area.

Police officers, enforcement officers, employees of the car-tow motoring companies can use the invention applying a portable mobile wireless communication terminal with an incorporated RFID and/or bar code scanner and/or a magnetic stripe reader and/or a key pad and/or a printer and/or a camera with the option of a biometric scanner and/or a fingerprint recognition module and/or a localisation module such as GPS (Global Positioning System) module, highly secured including a special interface software which is able to establish a real-time connection and communication with a database. This mobile device will have the ability to charge, invoice, control, film and take photo then send and receive online information over a wireless telecommunication network such as GSM and/or GPRS and/or UMTS and/or W-CDMA and/or i-mode etc. The mobile device also contains a special software with the biometrics feature in the background able to read, translate and transmit the requirements to a corresponding special database. This particular database translates the demand and retransmits the requested information immediately to the portable mobile and wireless communication terminal of the police or enforcement officer (i.e. the picture of a stolen car or a trace film of an important situation that happened in the past, or an incident in another place). The portable mobile and wireless communication device can react independently depending on the previously programmed features either in the database or in the portable terminal. On the other hand, the location module based on technologies such as GPS permits to determine the position of the agent itself or the position of any other person and/or car using this technology and add a more sophisticated system features in the control functions using a location based approach.

Driver identification prior to a transaction before using the invented method works as follows: The driver needs to register either via internet or directly by phone using an IVR system or through services established at the municipalities or even by regular mail, for getting access to the parking. Then authorities or service provider assign the driver an identification code and an RFID or Bluetooth biometric smart card corresponding to the driver vehicle and profile. At the time the transaction occurs, the parking database receives an identification code and a request for parking from the driver over the communications network, the system then request for a pin code that in connection to the vehicle number or the phone ID serves to identify the driver, the car and the account authorisation. After the user enters the personal identification code, the system checks first the validation of the request by seven security checks:

1. Caller emplacement (using the location register—VLR visitor location register and/or GPS information),

2. Caller personal identity number,

3. Caller preferred language,

4. Automated recognition of caller's voice.

5. Caller phone number,

6. Car plate number,

7. Bank account or E-wallet authorisation,

8. Caller's preferred currency.

In case of a positive authorisation, the transaction is confirmed, if not, the customer receives a notification that he needs either to recharge his account or call the help line to obtain a bank authorisation of the confirmed transaction. The system also works by camera and biometrics reconnaissance based on the car plate and/or user face and/or car model and/or car colour. The invention comprises an RFID and/or Bluetooth and/or biometric smart card that contains special data such as a bubble tag on the card and/or a biometric electronic code in the chip card or a special serial number. This measures protect the driver from fraud, when the driver needs to do a micro payment for parking.

The invention comprises also solutions for access to underground parking or street or other parking space with barrier system which is based on a biometric scanner camera that scan the car model with its colour and the plate number. The system works as follows: one or two cameras are placed at the entry of the parking. When a driver arrives for the first time in front of the parking entry, the RFID biometric smart card or sticker is identified, then the cameras scan the plate and the car model for recognition. Later on, the system calls the driver and asks him to enter his personal identification code. The system verifies then first the customer account to check for sufficient funds in order to proceed with the transaction. It modifies the user profile in the database and gives the order to open the barrier. The driver then receives a confirmation by SMS or MMS and like that his parking has been registered and that the amount of the parking will be charged to his virtual account or sent to his office. When the driver leaves the parking place the biometric scanning cameras identify the car and debit automatically the virtual driver account with the amount due. The next time the driver enter in a parking with the same solution he does not need to do anything, just wait a second and the barrier is opened. He will receive an SMS and/or MMS and like confirmation that his parking time authorisation started and that his driver account will be debited when he leaves the place.

A further application of the present invention is with respect to the payment of taxi services. A registered user calls a defined number of the service centre and/or sends a message to the predefined number. The identification of the user in the service is done based on the subscription data, phone number and/or the personal security and identification code. The user is located based on the location data of the mobile phone and/or any other localisation technique such as localisation based on localisation systems such as GPS and/or GPR and/or W-max and/or WLAN access points and/or Bluetooth nodes. The nearest available taxi is located on the other side and the request is send to the taxi, indicating the position of the user. The taxi driver can confirm or reject the request, either using the own mobile phone and/or any other device able to communicate with the taxi reservation service. The taxi can be equipped with dedicated devices with a visual display and/or voice instructions that would receive the request information and allow for communication with the service. As the system is bidirectional, the interactive voice system is also able to initiate calls, give vocal instructions and forward incoming calls to the user depending on the request type. Once the taxi driver confirms the request, the data records corresponding to the user are updated to take into account the current taxi drive and the user is sent a confirmation of the transaction to the personal communication device, such as mobile phone.

The bidirectional capacity of the interactive voice system can be illustrated more precisely based on the example of a car driver using the system. The IVR would then call the user and reproduce an automatic voice alert information about the road and weather conditions depending on the geographical position of the user as the system works with localisation systems such as GPS. This voice alert system is organised in a multitask way as it can advise the driver and other services (such as police department and/or ambulance and/or firebrigade) in the same time. The system can have the ability to analyse the situation and send out different alerts depending on the current conditions. Machine to machine communication can be based on communication systems such as PAD and/or computer and/or mobile phone and/or networks and/or phone and/or GPS and/or GSM and/or GPRS and/or UMTS and/or broadband internet and/or WLAN and/or W-max.

One further application of the present invention is the direct payment of traffic amends by car owners. In this example, the user would have to subscribe to the service via a telephone call to the transaction centre or by internet, provide all required data such as name, address, bank account number etc. and open a corresponding virtual account, and receive the identification tag 100, for example the RFID or Bluetooth sticker or any other smart card. The user would then install the received identification tag 100—i.e. RFID, Bluetooth sticker, smart card—on a place where it can be seen from devices and people being outside the car. The identification tag can preferably be placed behind the car window. When found in an authorised situation—i.e. unauthorised parking—the police officer and/or authorised employee would “charge” the amend directly on the identification tag 100. The user would then use the identification tag 100 to pay the amend at authorised places, such as post office, police station or any other suitable place. The transaction would follow following normal steps:

1. Give the identification tag 100 to the employee or introduce it into the machine. The reading device takes the identification data from the identification tag 100 and sends them to the central dispatching module 107 for further processing.

2. The central dispatching module 107 modifies the user data records adding the amount due and transmits them to the service module 105/106 corresponding to the police department or authorised company.

3. A confirmation of the transaction is sent to the mobile communication device of the user 109 via an SMS and/or MMS message. He might be asked to enter a personal identification code in order to validate the transaction.

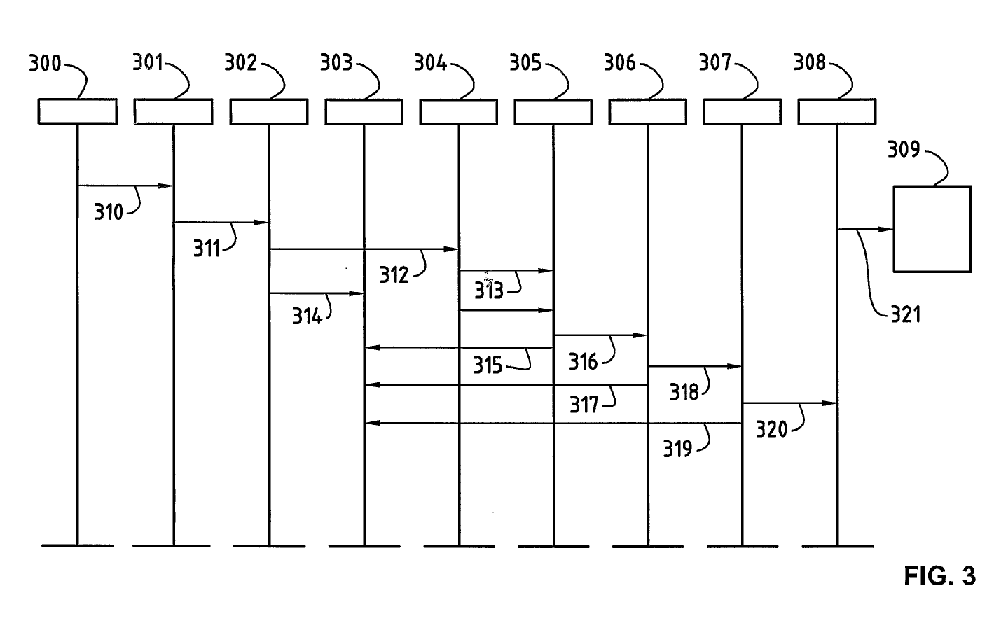

Moreover, the system and the method according to the present invention can be used in connection with the systems for fee collecting in the cities. This application is explained more in detail in FIG. 3. One or more reading devices 302 are placed at the entry of the predefined city zone where the fee should be collected. The car driver 300 puts the RFID smart card 301 in the car in the step 310, so that it can be read by the reading device 302. When the driver 300 arrives with the car in front of the reading device 302, the RFID smart card or sticker 301 sends the data to the reading device 302 in the step 311. Afterwards, the reading device 302 transmits the received data to the verification module 304 in the step 312 and to the temporary local database 303 in the step 314. The verification module 304 transmits the authorisation to the service dispatcher 305 in the step 313, which notifies the local database 303 about the authorisation of the user 300 in the step 315. Later on, the service dispatcher 305 notifies the fee collection service module 306 about the authorisation of the user 300 in the step 316, followed by the confirmation sent by the fee collection service module 306 to the local database 303 in the step 317. The fee collection module 306 then modifies the data records connected with the user 300, adding the entry date, time, location of the entrance into the fee zone and any other relevant data and transmits them to the database 307 in the step 318. The database 307 confirms the transaction to the local database 303 in the step 319. The final confirmation of the transaction is then sent to the mobile phone 308 of the user in the step 320. The user can also be notified about the transaction by means of an IVR communication system 309, which receives the needed data in the step 321.

It will be understood from the foregoing that the invention provides a great advance in transaction payment systems and methods creating a dynamic system that provides the optimal ease of use and integration of different services, in different languages and currencies, guaranteeing a maximal security and ubiquity of the transaction.

1. A method for transaction payment where user identification data are transmitted to a central dispatch module (107) over a first communication channel (101), where the user is identified in a databank (103) based on the user identification data, and where the transaction data are sent to a processing module (105/106), and where a confirmation of the transaction is sent to the user over a second communication channel (108), characterised in that
service identification data are transmitted to a central dispatch module (107) with the user identification data over the first communication channel (101),
the central dispatch module (107) compares the received user identification data with the user identification data stored in the authentication databank (103), and that a user is authenticated by means of the central dispatch module (107) if the probability of match of the received user identification and stored user identification data is above a predefined threshold,
after a successful authentication, the central dispatch module (107) retrieves one or more personal data records corresponding to the user from the databank (103) based on the user identification data and the service identification data, and modifies at least one personal data record of the user based on the time and/or place and/or mode of the data retrieval, and
the central dispatch module (107) transmits one or more personal data records of the user to at least one processing module (105/106) based on the service identification data and personal data records of the user.

2. The method for transaction payment according to claim 1, characterised in that the user identification data is stored in an identification module (100).

3. The method for transaction payment according to claim 2, characterised in that the identification module (100) is an RFID tag and/or a bubble tag and/or a SIM-card and/or a smart card with biometric information and/or a car plate.

4. The method for transaction payment according to any one of the claims 1 to 3, characterised in that the user identification data comprises voice and/or image data.

5. The method for transaction payment according to any one of the claims 1 to 4, characterised in that the first communication channel (101) is a GSM and/or GPRS and/or EDGE and/or UMTS and/or W-CDMA and/or SCDMA and/or WLAN and/or Bluetooth and/or DECT and/or satellite and/or GPS-and/or private radio network.

6. The method for transaction payment according to any one of the claims 1 to 5, characterised in that the personal data records of the user comprise image information.

7. The method for transaction payment according to any one of the claims 1 to 6, characterised in that the confirmation of the transaction is sent to a mobile communication device (109) of the user.

8. The method for transaction payment according to any one of the claims 1 to 7, characterised in that the confirmation of the transaction has a limited time validity.

9. The method for transaction payment according to any one of the claims 1 to 8, characterised in that the user validates the confirmation of the transaction through a personal identification code.

10. The method for transaction payment according to any one of the claims 1 to 9, characterised in that the central dispatch module (107) is implemented in a mobile device.

11. The method for transaction payment according to any one of the claims 1 to 10, characterised in that the processing modules (105/106) are redundant.

12. The method for transaction payment according to any one of the claims 1 to 11, characterised in that the underlying components of the system (210, . . . , 215) are organised in a ring and/or star architecture.

13. A system for transaction payment comprising means for transmitting user identification data to a central dispatch module (107) over a first communication channel (101), a databank (103) for identifying the user based on the user identification data, means (104) for transmitting the transaction data to a processing module (105/106), and means for sending a confirmation of the transaction to the user over a second communication channel (108), characterised in that it further comprises
means (100) for transmitting service identification data with the user identification data to a central dispatch module (107),
means (102) for comparing the received user identification data with the user identification data stored in the authentication databank (103), where a user is authenticated by means of the central dispatch module (107) if the probability of match of the received user identification and stored user identification data is above a predefined threshold,
means (102) for retrieving one or more personal data records corresponding to the authenticated user from the databank (103) based on the user identification data and the service identification data and modifying at least one personal data record of the user based on the time and/or place and/or mode of the data retrieval,
means (104) for transmitting one or more personal data records of the user from the central dispatch module (107) to at least one processing module (105/106) based on the service identification data and the personal data records of the user.

14. The system for transaction payment according to claim 13, characterised in that the system further comprises an identification module (100) for storing identification data of the user.

15. The system for transaction payment according to claim 14, characterised in that the identification module (100) is an RFID tag and/or a bubble tag and/or a SIM-card and/or a smart card with biometric information and/or a car plate.

16. The system for transaction payment according to any one of the claims 13 to 15, characterised in that the user identification data comprises voice and/or image data.

17. The system for transaction payment according to any one of the claims 13 to 16, characterised in that the first communication channel (101) is a GSM and/or GPRS and/or EDGE and/or UMTS and/or W-CDMA and/or SCDMA and/or WLAN and/or Bluetooth and/or DECT and/or satellite and/or GPS and/or private radio network.

18. The system for transaction payment according to any one of the claims 13 to 17, characterised in that the personal data records of the user comprise image information.

19. The system for transaction payment according to any one of the claims 13 to 18, characterised in that the confirmation of the transaction is sent to a mobile communication device 109 of the user.

20. The system for transaction payment according to any one of the claims 13 to 19, characterised in that the confirmation of the transaction has a limited time validity.

21. The system for transaction payment according to any one of the claims 13 to 20, characterised in that the user validates the confirmation of the transaction through a personal identification code.

22. The system for transaction payment according to any one of the claims 13 to 21, characterised in that the central dispatch module (107) is implemented in a mobile device.

23. The system for transaction payment according to any one of the claims 13 to 22, characterised in that the processing modules (105/106) are redundant.

24. The system for transaction payment according to any one of the claims 13 to 23, characterised in that the underlying components of the system (210, . . . , 215) are organised in a ring and/or star architecture.
